(19) United States
(12) Patent Application Publication
(10) Pub. No.: US 2008/0036796 A1
(43) Pub. Date: Feb. 14, 2008

(54) Method of providing image data to a panel with a delta arrangement of pixels and apparatus using the same

(75) Inventors: Yun-Chong Lin, Hemei Township (TW); Chih-Kuang Lin, Luodong Township (TW)

Correspondence Address: LIU & LIU, 444 S. FLOWER STREET, SUITE 1750, LOS ANGELES, CA, 90071, US

(73) Assignee: TPO Displays Corp.

(21) Appl. No.: 11/503,358

(22) Filed: Aug. 10, 2006

(51) Int. Cl. G09G 5/02

(52) U.S. Cl. 345/694

(57) ABSTRACT

Architecture for providing serial RGB data to be displayed in the panels with the delta arrangement of pixels is provided herewith. In the architecture, data sequence transmitted from an application specific integrated circuit (ASIC) to a panel of a device is modified to avoid the problem of saw-toothed images, which can improve the quality of displayed images. In the architecture, the image data is received for the panel and is converted to serial RBG data. The data sequence of the serial RGB data either for the pixels at an odd line or for the pixels at an even line of the delta arrangement in the panel is adjusted to avoid the problem of saw-toothed images.

### BACKGROUND OF THE INVENTION

1. Field of Invention

The present invention relates to method of providing image data to a panel with a delta arrangement of pixels. More particularly, the present invention relates to a method of providing image data to a panel with a delta arrangement of pixels by adjusting data sequence of serial RGB data applied to the panel with a delta arrangement of pixels.

2. Description of Related Art

Image data with different modes, such as YUV NTSC (National Television System Committee) mode, YUV PAL (Phase Alternating Line) mode, RGB Dummy QVGA (Quarter Video Graphics Array), RGB Dummy NTSC mode, RGB Dummy PAL mode, or Through mode (which is a Serial RGB mode), etc., is input to an application specific integrated circuit (ASIC) for a display device. The image data input to the ASIC will be converted to image data with the Through mode and then transmit the image data with the Through mode to a panel of the display device. That is, the input data transmitted to the ASIC will be converted to a 8-bit serial RGB data and then sequentially transmitted to the panel of the display device.

Please refer to FIG. 1, which shows input data and the output data according to a time sequence of a clock signal DCLK. No matter which mode the input data is applied with, the output data is converted by the ASIC to a serial RGB data in an order like “RGBRGBRGB . . . ”, in which the “RGB” respectively represent Red, Green and Blue color.

Pixels in panels of display devices are carefully arranged by, for example, a strip arrangement or a delta arrangement. As shown in FIG. 2, in the strip arrangement, the RGB pixels are regularly arranged each row, and, however, in the delta arrangement, as shown in FIG. 3A and FIG. 3B, the RGB pixels are irregularly arranged each row. Most of the panels in large-sized display devices use the strip arrangement to arrange the pixels, and the input serial RGB data supplied from the ASIC can be normally displayed in these pixels with the strip arrangement without any distortion. However, in some display devices, for example, the panels in some digital still cameras (DSCs), if the 8-bit input serial RGB data supplied from the ASIC is directly displayed in the panels with delta arrangement for pixels, a saw-toothed image will occur, which causes poor performance of the displayed images.

Please refer to FIG. 3B, if the serial RGB data is supplied to the panels with the delta arrangement of pixels in an alternative order of a odd line and an even line, in the conventional data sequence, it is apparent that the serial RGB data in the odd line and the serial RGB data in the even line has a 1.5 dot distance (denoted as “320”), which let the saw-toothed images occur.

### SUMMARY OF THE INVENTION

Present invention provides architecture for providing serial RGB data to be displayed in the panels with the delta arrangement of pixels. In the architecture, data sequence transmitted from an application specific integrated circuit (ASIC) to a panel of a device is modified to avoid the problem of saw-toothed images, which can improve the quality of displayed images.

In one embodiment, a method of providing image data to a panel with a delta arrangement of pixels is provided. In the method, the image data is received for the panel and is converted to serial RBG data. The data sequence of the serial RGB data either for the pixels at an odd line or for the pixels at an even line of the delta arrangement in the panel is adjusted to avoid the problem of saw-toothed images.

In the method above, the data sequence of the serial RGB data is adjusted according to an alignment difference between the pixels at the odd line and at the even line of the delta arrangement.

In the method above, the data sequence of the serial RGB data is adjusted according to the alignment difference between the pixels at the odd line and at the even line of the delta arrangement by shifting the serial RGB data for the first sub-pixel for a pre-determined number of dots later.

In another embodiment of the invention, an apparatus is provided. The apparatus comprises a panel, with a plurality of pixels arranged in a delta arrangement of pixels, for displaying images; and an application specific integrated circuit (ASIC) for receiving image data, converting the image data to serial RBG data, and adjusting data sequence of the serial RGB data either for the pixels at an odd line or for the pixels at an even line of the delta arrangement in the panel.

In the apparatus above, the data sequence of the serial RGB data is adjusted according to an alignment difference between the pixels at the odd line and at the even line of the delta arrangement. In one embodiment, the data sequence of the serial RGB data is adjusted according to the alignment difference between the pixels at the odd line and at the even line of the delta arrangement by shifting the serial RGB data for the first sub-pixel for a pre-determined number of dots later.

In order to the make the aforementioned and other objects, features and advantages of the present invention comprehensible, a preferred embodiment accompanied with figures is described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 shows input data and the output data according to a time sequence of a clock signal DCLK in a conventional ASIC device.

FIG. 2 shows a strip arrangement of RGB pixels in a panel of a display device.

FIGS. 3A and 3B show a delta arrangement of RGB pixels in a panel of a display device.

FIG. 4 shows a serial RGB data supplied to the panel with the delta arrangement of pixels in an alternative order of a odd line and an even line, in the conventional data sequence and in a data sequence of a preferred embodiment of the invention.

FIG. 5 shows an improved data sequence of the preferred embodiment of the invention by the ASIC.

FIG. 6 shows a device with an ASIC and a panel with the delta arrangement of the preferred embodiment of the invention.

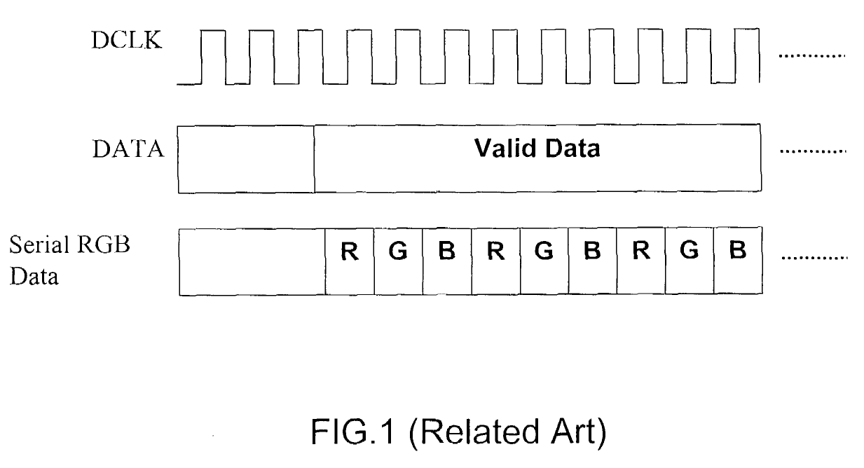

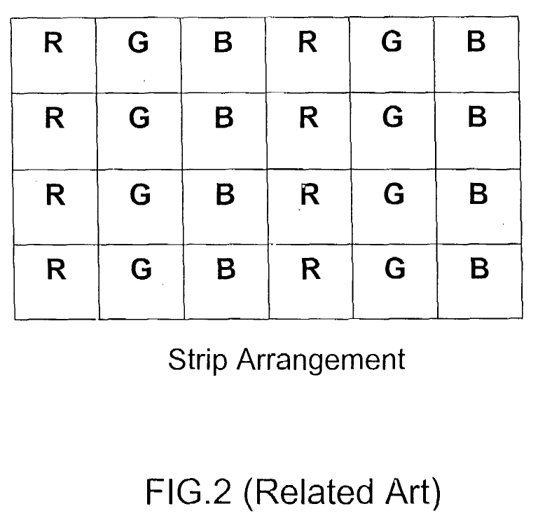

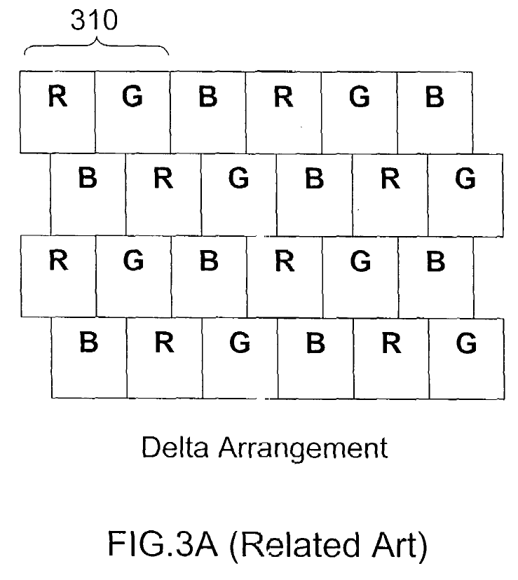

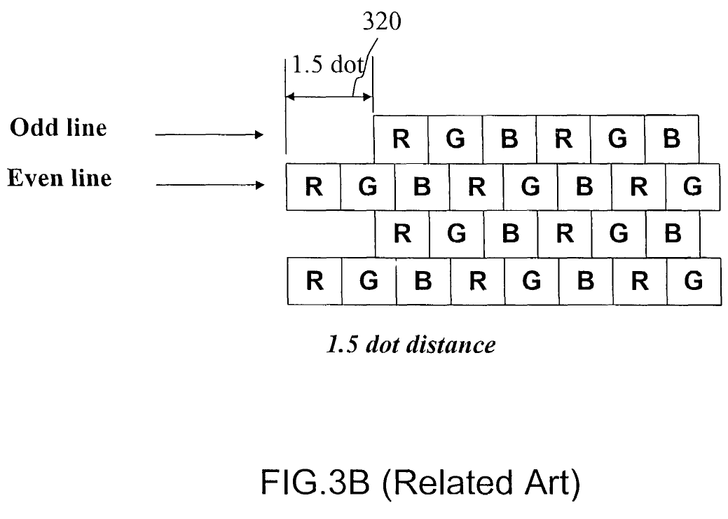

### DESCRIPTION OF EMBODIMENTS

Architecture for providing serial RGB data to be displayed in the panels with the delta arrangement of pixels is provided herewith. In the architecture, data sequence transmitted from an application specific integrated circuit (ASIC) to a panel of a device is modified to avoid the problem of saw-toothed images, which can improve the quality of displayed images. In the proposed solution, no further unnecessary modification is required for the hardware of the device, instead, only modification of data sequence from the ASIC is required.

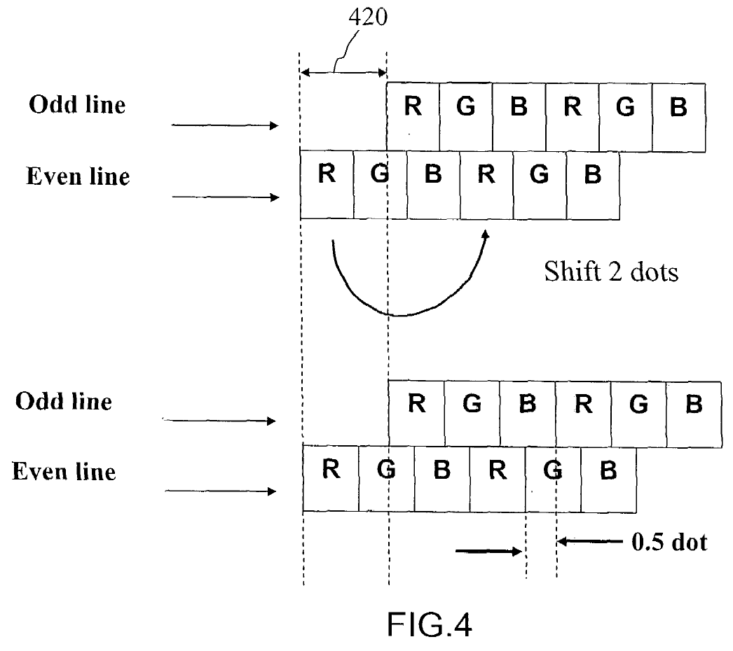

Please refer to an upper part of FIG. 4, if the serial RGB data is supplied to the panels with the delta arrangement of pixels in an alternative order of a odd line and an even line, in the conventional data sequence, it is apparent that the serial RGB data applied to the pixels at the odd line and the serial RGB data applied to the pixels at the even line has an alignment difference, for example, 1.5 dot distance, which is denoted as reference number 410. The alignment difference will causes the problem of the saw-toothed images. To avoid the problem of saw-toothed images, data sequence for the even lines is modified as required.

Please refer to a lower part of FIG. 4, which shows a preferred embodiment of architecture for providing serial RGB data to be displayed in the panels with the delta arrangement of pixels. When the ASIC begins to transmitting the data to the panel, the data is separated into data for the odd line and data for the even line in advance by the ASIC, and the first sub-pixel of the data for each even line is shifted two dots later. For example, as shown in the lower part of FIG. 4, if the data for the even line is in an order of “RGBRGBRGB . . . ”, the data for the first sub-pixel “R” is shifted two dots later and the order for the even line becomes “GBRGBRGB . . . . ” By such modification, the serial RGB data applied to the odd line and the serial RGB data applied to the even line has become only 0.5 dot in distance and will significantly improve the quality of displayed images. The distance that the first sup-pixel of the data for each even line should be shifted is determined according to the delta arrangement of pixels in the panel.

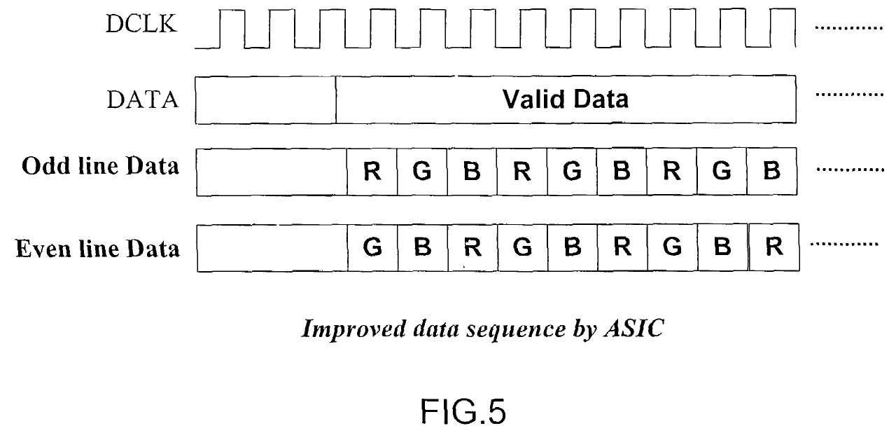

The adjusted data sequence of the preferred embodiment of the invention in the ASIC is shown in FIG. 5. When the image data is input to the ASIC, the input data will be converted to serial RGB data. The serial RGB data from the ASIC to a panel of a display device is first separated into data for the odd line and data for the even line in advance, for example, “RGBRGBRGB . . . ” for each of the odd lines and the “GBRGBRGB . . . ” for each of the even lines. The data for the odd lines and for the even lines is supplied to the panel of the display device according to a time sequence of a clock signal DCLK.

The invention provides architecture for providing serial RGB data to be displayed in the panels with the delta arrangement of pixels, which can avoid the problem of saw-toothed images and can improve the quality of displayed images. In the proposed solution, no further unnecessary modification is required for the hardware of the device, instead, only modification of data sequence from the ASIC is required, which can reduce the cost and concurrently improve the quality.

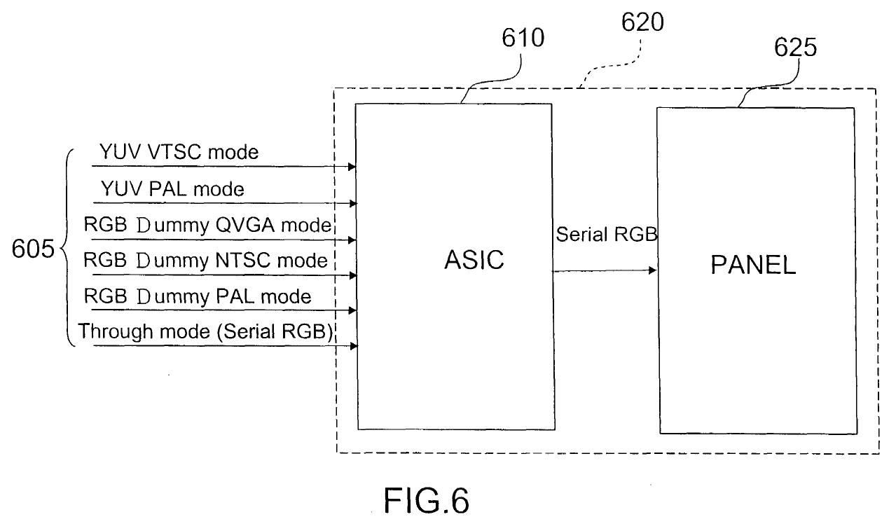

In the architecture for providing serial RGB data to the panels with the delta arrangement of pixels, an application specific integrated circuit (ASIC) is introduced in FIG. 6. Image data 605 with different modes, such as a display device includes YUV NTSC (National Television System Committee) mode, YUV PAL (Phase Alternating Line) mode, RGB Dummy QVGA (Quarter Video Graphics Array), RGB Dummy NTSC mode, RGB Dummy PAL mode, or Through mode (which is a Serial RGB mode), etc. is input to the ASIC 610 and is then converted to image data with the Through mode. Then the Serial RGB image data is then transmitted to a panel 625 of an electronic device 620, where arrangement of the pixels in the panel 625 is the delta arrangement. The electronic device 620 can be a display device, a digital still camera (DSC), a mobile phone, a photo printer, or a personal digital assistant (PDA) or any electrical devices with a display panel, in which arrangement of the pixels is the delta arrangement.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. Method of providing image data to a panel with a delta arrangement of pixels, the method comprising:
receiving the image data for the panel;
converting the image data to serial RBG data; and
adjusting data sequence of the serial RGB data either for the pixels at an odd line or for the pixels at an even line of the delta arrangement in the panel.

2. The method as claimed in claim 1, wherein the data sequence of the serial RGB data is adjusted according to an alignment difference between the pixels at the odd line and at the even line of the delta arrangement.

3. The method as claimed in claim 2, wherein the data sequence of the serial RGB data is adjusted according to the alignment difference between the pixels at the odd line and at the even line of the delta arrangement by shifting the serial RGB data for the first sub-pixel for a pre-determined number of dots later.

4. The method as claimed in claim 3, wherein if the data sequence of the serial RGB data for the pixels at the even line of the delta arrangement in the panel is adjusted, all of the data sequence of the serial RGB data for the pixels at every one of the even lines of the delta arrangement in the panel are adjusted by shifting the serial RGB data for the first sub-pixel for the pre-determined number of dots later.

5. The method as claimed in claim 1, wherein the image data received for the panel is in a YUV NTSC (National Television System Committee) mode.

6. The method as claimed in claim 1, wherein the image data received for the panel is in a YUV PAL (Phase Alternating Line) mode.

7. The method as claimed in claim 1, wherein the image data received for the panel is in a RGB Dummy QVGA (Quarter Video Graphics Array) mode.

8. The method as claimed in claim 1, wherein the image data received for the panel is in a RGB Dummy NTSC mode.

9. The method as claimed in claim 1, wherein the image data received for the panel is in a RGB Dummy PAL mode.

10. The method as claimed in claim 1, wherein the image data received for the panel is in a Through mode.

11. An apparatus, comprising:
a panel, with a plurality of pixels arranged in a delta arrangement of pixels, for displaying images; and
an application specific integrated circuit (ASIC) for receiving image data, converting the image data to serial RBG data, and adjusting data sequence of the serial. RGB data either for the pixels at an odd line or for the pixels at an even line of the delta arrangement in the panel.

12. The apparatus as claimed in claim 11, wherein the data sequence of the serial RGB data is adjusted according to an alignment difference between the pixels at the odd line and at the even line of the delta arrangement.

13. The apparatus as claimed in claim 12, wherein the data sequence of the serial RGB data is adjusted according to the alignment difference between the pixels at the odd line and at the even line of the delta arrangement by shifting the serial RGB data for the first sub-pixel for a pre-determined number of dots later.

14. The apparatus as claimed in claim 11, wherein the apparatus is a digital still camera (DSC), a mobile phone, a photo printer, or a personal digital assistant (PDA).

15. The apparatus as claimed in claim 11, wherein the image data received by the ASIC is in a YUV NTSC (National Television System Committee) mode.

16. The apparatus as claimed in claim 11, wherein the image data received by the ASIC is in a YUV PAL (Phase Alternating Line) mode.

17. The apparatus as claimed in claim 11, wherein the image data received by the ASIC is in a RGB Dummy QVGA (Quarter Video Graphics Array) mode.

18. The apparatus as claimed in claim 11, wherein the image data received by the ASIC is in a RGB Dummy NTSC mode.

19. The apparatus as claimed in claim 11, wherein the image data received by the ASIC is in a RGB Dummy PAL mode.

20. The apparatus as claimed in claim 11, wherein the image data received by the ASIC is in a Through mode.
